(19) United States
(12) Patent Application Publication
(10) Pub. No.: US 2024/0288298 A1
(43) Pub. Date: Aug. 29, 2024

(54) TANK SYSTEM

(71) Applicant: DEERE & COMPANY, MOLINE, IL (US)

(72) Inventors: SATHISH THIRUMALAI, CHENNAI (IN); VINAYAK JOSHI, PUNE (IN); DEVIDAS D. SATAVALEKAR, PUNE (IN); SAURABH MISHRA, MAIHAR (IN)

(21) Appl. No.: 18/583,320

(22) Filed: Feb. 21, 2024

(30) Foreign Application Priority Data
Feb. 27, 2023 (DE) 102023104694.2

(51) Int. Cl. G01F 23/18; B60K 15/03

(52) U.S. Cl. CPC G01F 23/18; B60K 15/03; B60K 2015/03217

(57) ABSTRACT

A tank system having a tank container for filling with a fuel and having a sensor assembly for determining a current fuel quantity in the tank container, including a pressure sensor, and an air channel arranged at least in part inside the tank container and pneumatically connected at a first channel end to the pressure sensor, and the air channel is oriented in the direction toward a container bottom of the tank container at an open second channel end opposite the first channel end.

### CROSS-REFERENCE TO RELATED APPLICATIONS

This application claims priority to German Patent Application No. 102023104694.2, filed Feb. 27, 2023, which is hereby incorporated by reference.

### FIELD OF THE DISCLOSURE

The disclosure relates to a tank system having a tank container for filling with a fuel and having a sensor assembly for determining a current fuel quantity in the tank container.

### BACKGROUND

Such tank systems serve to determine the fuel quantity in the tank container of a vehicle by means of suitable sensors. Sensor signals generated by the sensors are represented in processed form on a display unit of the vehicle in order to display the current fuel quantity, or the current filling level, in the tank container to the driver or user.

### SUMMARY

The present disclosure is based on the object of improving the accuracy in the determination of the current fuel quantity in the tank container.

This object is achieved by a tank system having the features of one or more of the following embodiments.

Further advantageous refinements of the tank system according to the disclosure can be found in one or more of the following embodiments.

According one embodiment, the tank system has a tank container for filling with a fuel. The tank system further has a sensor assembly for determining a current fuel quantity in the tank container. The sensor assembly contains a pressure sensor. The sensor assembly additionally has an air channel which is arranged at least in part or wholly inside the tank container. The air channel is pneumatically connected at a first channel end to the pressure sensor. At an open second end opposite the first channel end, the air channel is oriented in the direction toward a container bottom of the tank container.

The air channel is configured as a type of air column, air tube or capillary column. The air channel can be flexible or rigid.

Arranging the air channel at least in part in the tank container generates different air pressures in the air channel in dependence on the filling height or level of the fuel quantity. A physically simple and particularly accurate relationship between the level of the fuel quantity and sensor signals of the sensor assembly can thus be provided. A contribution is also made by the open second channel end, which effects a permanent pneumatic and fluidic connection between the air channel and the container interior. This allows the current fuel quantity to be determined and displayed particularly accurately at any time during operation of the vehicle.

The physical relationship between the air pressure of the air channel and sensor signals of the sensor assembly in particular permits a linear or proportional detection of the filling height or of the filling level of the fuel from a particularly high filling height to a particularly low filling height, which technically facilitates the determination and display of the current fuel quantity with maximum accuracy.

The principle of this tank system is also particularly suitable for accurately determining the current fuel quantity in the case of one or more combined tank containers which have irregular contours of the inner volume.

The tank system can be used in different categories of vehicle. The tank system provides efficient support in the case of utility vehicles, for example in the case of agricultural utility vehicles (e.g. a tractor), construction machines and forestry machines.

The improved determination of the current fuel quantity according to the method assists those involved (e.g. driver, user, owner, dealer, fleet manager) in using filling level data, for example for the precise planning and performance of specific consumption strategies.

The open second channel end is part of a lower channel portion of the air channel which runs in a laterally offset manner relative to an upper channel portion in the direction toward the container bottom. This geometry of the air channel can assist the measurement accuracy in the determination of the current fuel quantity in particular at low filling levels. The lateral offset can be implemented, for example, by a lower channel portion which extends at an angle or with a bend relative to the upper channel portion.

In one embodiment, the air channel extends in the direction toward the container bottom in such a manner that the open second channel end of the air channel touches, or mechanically contacts, the container bottom. Particularly low filling levels can thus be detected by measurement and the display accuracy in the case of relatively low fuel quantities in the tank container can be further improved.

The pressure sensor is arranged on an outer side of the tank container. The conventional outlay for ascertaining the technically most advantageous position of a sensor inside the tank container is thus not necessary. In addition, specific measurement inaccuracies can more easily be avoided.

In one embodiment, the first channel end of the air channel is pneumatically connected to the pressure sensor by way of a coupler or coupling device. The coupling device between the pressure sensor and the air channel thus acts as a suitable pneumatic-mechanical adapter, which makes the positioning and attachment of the sensor assembly on the tank container particularly simple in terms of mounting.

Particularly reliable and precise operation of the pressure sensor is obtained when it contains a membrane which is movable or is deflected against the pressure present in the air channel. In this way, the movements of the membrane are in a direct and thus physically reliable relationship with any change in the filling level. This relationship is in particular linear or proportional.

The membrane is coupled with an electric circuit, in such a manner that the circuit generates electrical signals which are dependent on a movement of the membrane. The pressure sensor is thus able to deliver suitable electrical output signals, which makes the determination of the current filling level, or of the current fuel quantity, technically simple. For example, the output signals are an electrical voltage, the values of which fall or rise in dependence on the changing filling level. In particular, the electrical voltage signals are proportional to the filling level, or fuel quantity.

In order to assist with simple mounting of the sensor assembly on the tank container, the air channel is fixed to a mounting base, which is configured to close a container opening of the tank container. The air channel can thus be positioned inside the tank container through the container opening in a manner that is simple in terms of mounting. In particular, when the container opening is closed by means of the mounting base, the air channel is automatically arranged in the required position.

The mounting base is configured in a space-saving manner as a plate or a cover, for example. In particular, the container opening is arranged at a location of the tank container that is above the maximum filling level.

In one embodiment, the mounting base is fixedly connected to the tank container by fasteners or fastening means and ensures that the container opening is securely closed. The fasteners or fastening means (e.g. screws) are configured for a releasable fastening, so that any maintenance and repair work on the tank system is possible with a low outlay in terms of mounting.

The tightness of the tank container in the region of its container opening is ensured particularly effectively when sealing means are used, which are arranged on the side of the mounting base that faces the container opening. The sealing means can thus be fixed automatically by clamping between the mounting base and the edge of the container opening during fastening of the mounting base, which assists with a stable sealing action.

In one embodiment, the coupling device is arranged on the side of the mounting base that is remote from the container opening. This allows the sensor assembly as a whole to be handled easily during mounting, maintenance and repair work.

The sensor assembly, or the pressure sensor, is connected to a data processing unit (e.g. as part of a control unit) for evaluating electrical signals of the sensor assembly. The current fuel quantity in the tank container can be determined in dependence on this evaluation.

In particular, the determined current fuel quantity is indicated on a suitable display unit or further processed as filling level data for the derivation of vehicle-related decisions or measures.

The determination of the current fuel quantity is carried out in dependence on a detected filling level, or a detected filling height, of the fuel in the tank container. Electrical signals of the sensor assembly which represent the filling height of the fuel are advantageously evaluated.

The electrical signals of the sensor assembly are in particular output signals (e.g. an electrical voltage) of the pressure sensor.

For as accurate a determination of the fuel quantity as possible, the filling height is linked with supplied characteristic data of the tank container, so that the current fuel quantity is determined in dependence on the filling height and the characteristic data. It is thus possible to take account of different specific container profiles of tank containers, in which different fuel quantities are present despite the filling level being the same.

In particular, the characteristic data specific to the tank container are stored in a data processing unit (e.g., as part of a controller including a processor and memory) and can be retrieved for the determination of the current fuel quantity. The characteristic data are, for example, tabular values or characteristic curves specific to the tank container.

In one embodiment, the characteristic data represent a ratio between the filling height and a corresponding volume in the fuel container. By means of such characteristic data, the fuel quantity can be determined particularly accurately in a manner specific to the tank container. At the same time, the computational outlay for corresponding algorithms remains low.

In driving operation (e.g. acceleration or braking), movements of the fuel in the tank container can make the determination of the current fuel quantity less accurate. For example, the instantaneous filling height of the fuel in the tank container at a particular time may differ from the actual filling height when traveling at a steady speed or when stationary.

The instantaneous fuel quantity is therefore determined at different times (in particular during driving operation). A mean value which represents the current fuel quantity is then formed from the determined instantaneous fuel quantities. In this way, inaccuracies in the determination of the current fuel quantity, in particular during driving operation, can effectively be averaged out and thus reduced.

The mean value can be calculated from a plurality of instantaneous fuel quantities as an arithmetic average value for a particular period of time. Alternatively, the mean value can be defined mathematically other than as the arithmetic mean.

In order to make the information or data relating to the current fuel quantity even more stable for the data user (e.g. driver, fleet management), it is provided that the above-mentioned determined mean value is retained as the valid current fuel quantity (e.g. for indication on a display unit) until a new mean value is formed, which replaces the previous mean value. Replacement requires a predefined difference between the previous mean value and the new mean value and can be correspondingly controlled, for example, by an algorithm.

The above and other features will become apparent from the following detailed description and accompanying drawings.

### BRIEF DESCRIPTION OF THE DRAWINGS

The tank system according to the disclosure is explained in more detail hereinafter with reference to the appended drawings. Components of comparable or corresponding function are identified here by the same reference signs. In the drawings:

FIG. 1 shows a perspective sectional view of a tank container of the tank system according to the disclosure having a sensor assembly;

FIG. 2 shows an enlarged side view of the sensor assembly according to FIG. 1;

FIG. 3 shows an enlarged view of detail III according to FIG. 2;

FIG. 4 shows an enlarged top view of a pressure sensor;

FIG. 5 shows a schematic side view of the tank system with different fuel quantities indicated;

FIG. 6 shows a schematic view of details of the pressure sensor used;

FIG. 7 shows a characteristic curve with a ratio between a filling height and a volume in the tank container; and

FIG. 8 shows a diagram with the current fuel quantity as a mean value of a plurality of instantaneous fuel quantities.

### DETAILED DESCRIPTION

The embodiments or implementations disclosed in the above drawings and the following detailed description are not intended to be exhaustive or to limit the present disclosure to these embodiments or implementations.

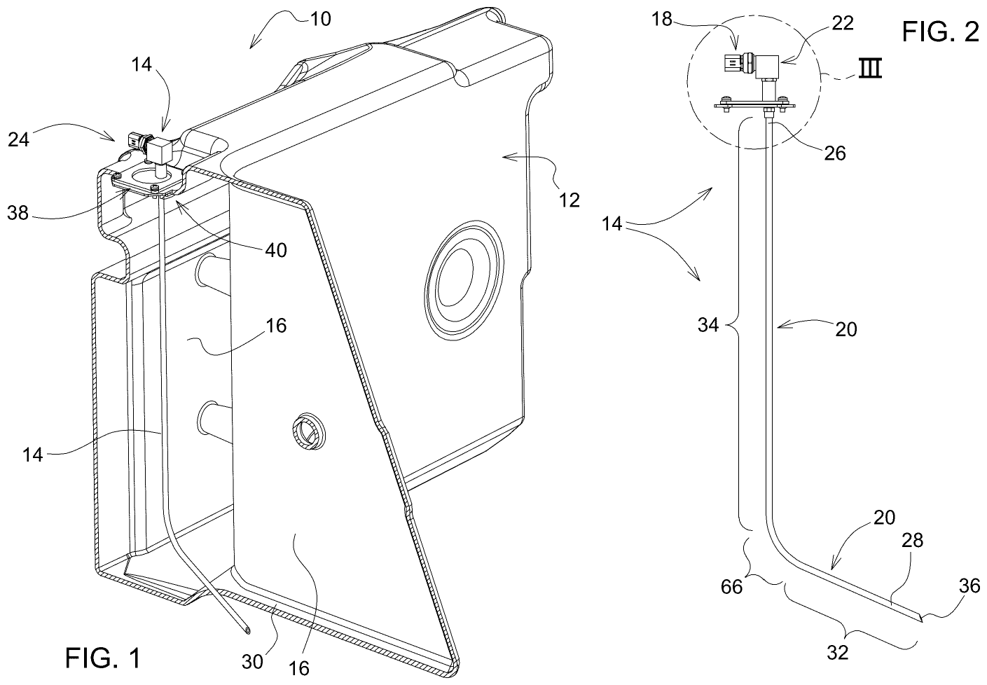

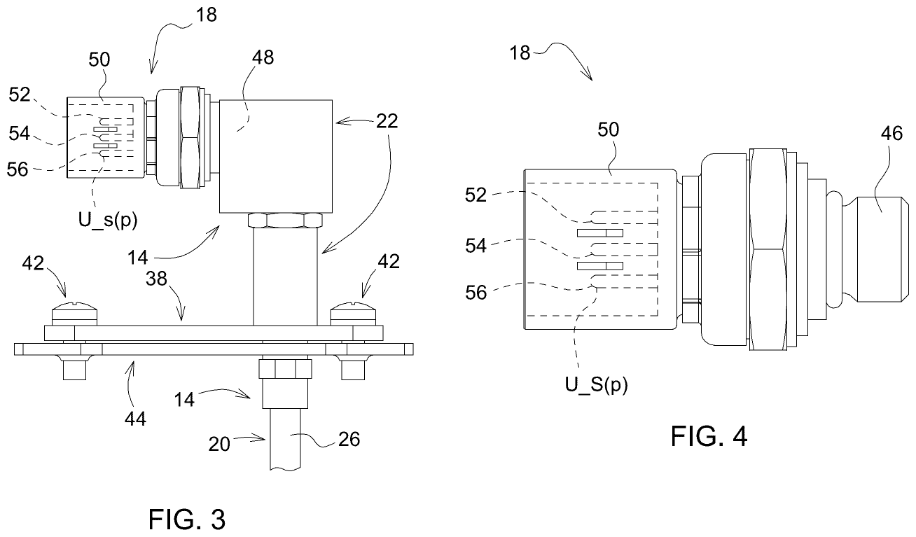

FIG. 1 shows a tank system 10 having a tank container 12 and a sensor assembly 14 arranged thereon. The tank container 12 is shown in section looking at a container interior 16 which can be filled with fuel. The sensor assembly 14 serves to determine a current fuel quantity in the tank container 12.

FIG. 2 shows the sensor assembly 14 on an enlarged scale. It has a pressure sensor 18 and an air column or air channel 20. The pressure sensor 18 and the air channel 20 are pneumatically connected together via a coupler or coupling device 22.

It can be seen in FIG. 1 that the pressure sensor 18 is arranged outside the tank container 12 on an outer side 24. The air channel 20 is arranged in the container interior 16. The air channel 20 is connected at a first axial channel end 26 to the pressure sensor 14 by way of the coupling device 22. An open second channel end 28 of the air channel 20 that is axially opposite the first channel end 26 is oriented toward a container bottom 30 of the tank container 12. The orientation is in particular such that the open second channel end 28 touches the container bottom 30. The second channel end 28 is part of a lower channel portion 32 of the air channel 20 which runs in the direction toward the container bottom 30 in a laterally offset manner relative to an upper channel portion 34 that extends perpendicularly. The lower channel portion 32 is arranged at an angle relative to the upper channel portion 34. The two channel portions 32, 34 are connected together by way of a bent intermediate portion 66 arranged therebetween.

The angled arrangement of the lower channel portion 32 and a beveled opening 36 at the second channel end 28 facilitate the ingress of the fuel into the air channel 20 and assist with the measurement accuracy in the determination of the current fuel quantity.

For simple mounting of the sensor assembly 14 on the tank container 12, a plate-like mounting base 38 is provided. The mounting base 38 serves to close a container opening 40 of the tank container 12. The sensor assembly 14 is fixedly and in particular releasably connected to the mounting base 38, so that the sensor assembly 14 is automatically positioned in the desired manner on and in the tank container 12 as soon as the mounting base 38 has been fastened to the tank container 12.

In one embodiment, the mounting base 38 is fixedly connected to the tank container 12 by means of four screws 42 which are each arranged at a corner of the plate-like mounting base 38. In the case of this fastening, a seal 44 is clamped between the mounting base 38 and an edge of the container opening 40. The seal 44 is arranged on the side of the mounting base 38 that faces the container opening 40, and it effects an outwardly sealed container interior 16. To this end, the seal 44 is configured so as to be adapted to the geometry of the container opening 40, for example ring-like, frame-like or disk-like.

FIG. 4 shows a pressure sensor 18 having an axially outer coupling portion 46 which is pneumatically connected to a connection socket 48 of the coupling device 22. The pressure sensor 14 and the coupling device 22 are thus releasably coupled together. In this manner, a pneumatic connection is also established between the pressure sensor 14 and the first channel end 26 of the air channel 20.

Axially opposite the coupling portion 46, the pressure sensor 14 has a connection portion 50. The connection portion can contain electrical connections, for example a voltage connection 52, a ground connection 54 and a signal connection 56. A connection cable provided therefor can be connected to the connection portion 50 in order to supply voltage to the pressure sensor 18 and in order to tap output signals U_s at the signal connection 56.

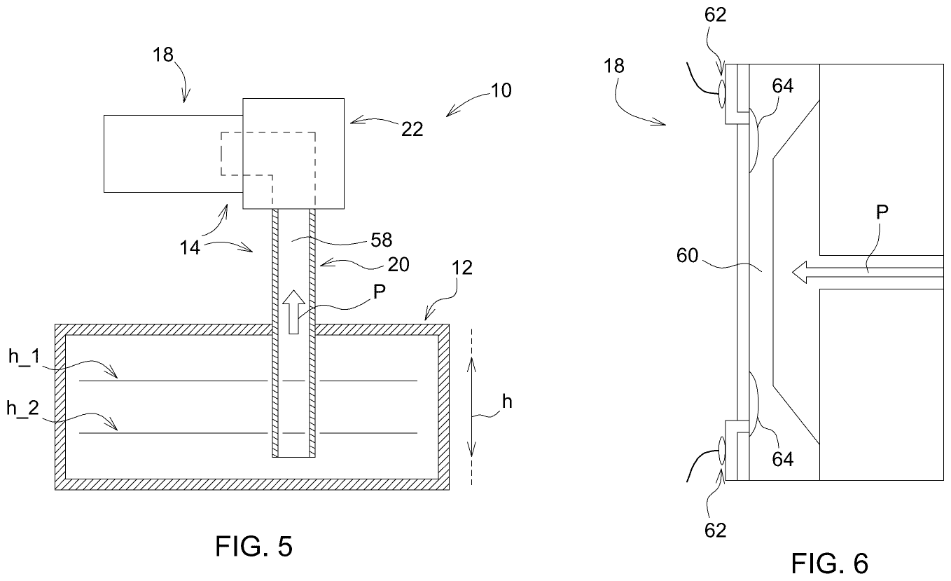

The functional principle of the sensor assembly 14 can be seen in FIG. 5. In the case of a filling height h_1 of the fuel, the air column 58 inside the air channel 20 is shorter than in the case of a lower filling height h_2 of the fuel. Accordingly, a pressure p against the pressure sensor 18 varies in dependence on the filling height h.

The varying pressure p is used to act on a membrane 60 contained in the pressure sensor 14 (FIG. 6). The membrane 60 is coupled with an electric or electronic circuit 62 in such a manner that its pressure-related membrane movements change one or more electrical resistances 64 and/or other electrical resistances of the circuit 62. Output signals U_s having signal values that are dependent on the pressure p and consequently dependent on the filling height h can thus be measured at the signal connection 56. In particular, there is a linear or proportional relationship between the output signal U_s and the pressure p or filling height h.

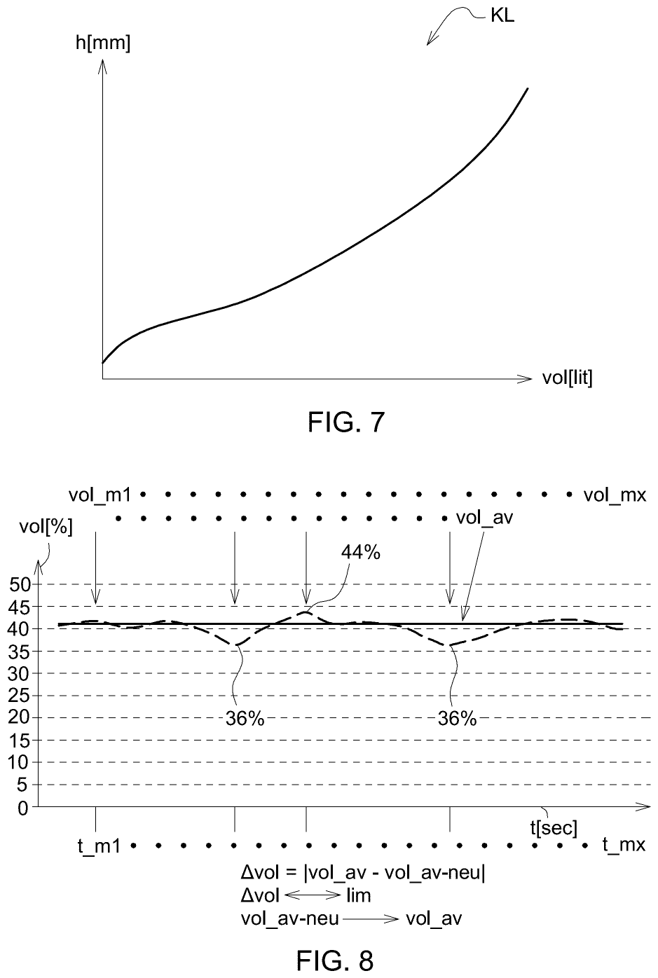

The output signals U_s of the pressure sensor 18 thus represent the filling height h. However, owing to different geometric configurations of the tank container 12, the same filling heights h can mean different fuel quantities. In order to determine the actual current fuel quantity, a specific characteristic curve KL that is generated for the tank container 12 in question is therefore provided, the characteristic curve representing a ratio between the filling height h (e.g. in mm) and the volume vol (e.g. in liters) of the container interior 16 up to that filling height h (FIG. 7).

FIG. 8 shows a measure for averaging out the current fuel quantity vol_av over a particular period of time, so that instantaneous fluctuations in the determined fuel quantity owing to particular driving situations (e.g. braking, acceleration) are taken into account in the determination of the actual current fuel quantity. The instantaneous fuel quantities vol_m1 to vol_mx are first determined by means of the above-described sensor assembly 14 at different times t_m1 to t_mx.

In the example according to FIG. 8, the fuel quantities are shown in %, wherein 100% corresponds to the maximum filling height h, or a full tank container 12.

For example, in the diagram according to FIG. 8, the instantaneous fuel quantity vol_mx at two different times t_mx is in each case 36% and at another intermediate time t_mx is approximately 44%. The mean value vol_av of the current fuel quantity is formed from the large number of instantaneous fuel quantities vol_mx that are determined and is approximately 41% in FIG. 8. A stable current fuel quantity without instantaneous fluctuations can thus be displayed to the user or driver.

A changed current fuel quantity is displayed, for example, if, when the current fuel quantity is repeatedly determined, a new mean value vol_av-neu is formed and the absolute value of the difference between the previous mean value vol_av and the new mean value vol_av-neu exceeds a predefined limit value lim. The new mean value vol_av-neu can then replace the previous mean value vol_av.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A tank system having a tank container for filling with a fuel and having a sensor assembly for determining a current fuel quantity in the tank container, comprising:
a pressure sensor; and
an air channel arranged at least in part inside the tank container and pneumatically connected at a first channel end to the pressure sensor, and the air channel is oriented in the direction toward a container bottom of the tank container at an open second channel end opposite the first channel end.

2. The tank system of claim 1, wherein the second channel end of the air channel is part of a lower channel portion of the air channel which runs in a laterally offset manner relative to an upper channel portion in the direction toward the container bottom.

3. The tank system of claim 1, wherein the pressure sensor is arranged on an outer side of the tank container.

4. The tank system of claim 1, wherein the first channel end of the air channel is pneumatically connected to the pressure sensor via of a coupler.

5. The tank system of claim 1, wherein the pressure sensor contains a membrane which is movable against the pressure present in the air channel.

6. The tank system of claim 5, wherein the membrane is coupled with an electric circuit of the pressure sensor, in such a manner that the circuit generates electrical signals which are dependent on a movement of the membrane.

7. The tank system of claim 4, wherein the air channel is fixed to a mounting base, which is configured to close a container opening of the tank container.

8. The tank system of claim 7, wherein the mounting base is fixedly connected to the tank container by fasteners.

9. The tank system of claim 7, wherein the mounting base has a seal on its side that faces the container opening.

10. The tank system of one of claim 7, wherein the coupler is arranged on the side of the mounting base that is remote from the container opening.

11. The tank system of claim 1, wherein the determination of the current fuel quantity is carried out in dependence on a filling height of the fuel in the tank container.

12. The tank system of claim 11, wherein electrical signals of the sensor assembly represent the filling height of the fuel.

13. The tank system of claim 11, wherein characteristic data which are dependent on the tank container are provided for determining the current fuel quantity in dependence on the filling height and the characteristic data.

14. The tank system of claim 1, wherein the current fuel quantity is formed as a mean value from instantaneous fuel quantities determined at different times.

15. The tank system of claim 14, wherein the previous mean value is valid until a new mean value is formed to replace the previous mean value.
